(19) United States
(12) Patent Application Publication
(10) Pub. No.: US 2026/0145360 A1
(43) Pub. Date: May 28, 2026

(54) METHOD FOR MANUFACTURING RECYCLED FIBER INSULATION BOARD FOR FIREPROOF DOORS AND THE RECYCLED FIBER INSULATION BOARD THEREOF

(71) Applicant: JTS CO., LTD., Yeongcheon-si (KR)

(72) Inventor: Seung Won LEE, Daegu (KR)

(21) Appl. No.: 19/392,815

(22) Filed: Nov. 18, 2025

(30) Foreign Application Priority Data
Nov. 25, 2024 (KR) 10-2024-0169677

(51) Int. Cl. B27N 3/00; B27N 3/04; B27N 7/00

(52) U.S. Cl. CPC B27N 3/007; B27N 3/04; B27N 7/00

(57) ABSTRACT

The present disclosure relates to a method for manufacturing a recycled fiber insulation board for fireproof doors that has excellent thermal insulation and is optimized for conditions required for a filling material for fireproof doors by using a fiber-based insulation material that is difficult to dispose of as waste, and a recycled fiber insulation board manufactured by the method. The present disclosure provides a recycled fiber insulation board having random fiber orientation and excellent water repellency by processing fiber-based insulation material waste, which has conventionally been disposed of by landfill, through a relatively simple method, thereby providing a recycled fiber insulation board for fireproof doors that has excellent heat resistance, thermal insulation, strength, and moisture resistance at low cost. Accordingly, the present disclosure has an effect of improving the quality of fireproof doors to which the recycled fiber insulation board is applied as a filling material while reducing manufacturing costs.

### CROSS REFERENCE TO RELATED APPLICATION

The present application claims priority to Korean Patent Applications No. 10-2024-0169677, filed Nov. 25, 2024, the entire contents of which are incorporated herein for all purposes by this reference.

### BACKGROUND

### Technical Field

The present disclosure relates to a method for manufacturing a recycled fiber insulation board for fireproof doors and a recycled fiber insulation board thereof and, more particularly, to a method for manufacturing a recycled fiber insulation board for fireproof doors that has excellent thermal insulation and is optimized for conditions required for a filling material for fireproof doors by using a fiber-based insulation material that is difficult to dispose of as waste, and a recycled fiber insulation board manufactured by the method.

### Description of the Related Art

Building codes or fire safety laws require buildings of a certain scale or larger to form fire compartments that divide interior spaces in order to prevent the spread of fire and to protect human life, and require fireproof doors to be installed between the fire compartments to delay the spread of flames and smoke.

Accordingly, the inside of a fireproof door is filled with an internal material that satisfies conditions such as not only thermal insulation and non-combustibility, but also support for loads, maintenance of strength against impact, and maintenance of component performance.

In the related art, a foaming agent having heat resistance was sometimes filled inside a fireproof door, but a foamed insulation material has limitations in that it has relatively low heat resistance and is difficult to fill uniformly, and therefore cases of inserting an insulation material made of mineral wool, which is an inorganic fiber material, have recently increased.

In a dictionary definition, mineral wool is defined as a generic term for cotton-like materials made of mineral fibers and is defined to include asbestos, rock wool, glass wool, slag wool, etc.

As described above, mineral wool is a generic term for all fibers made of inorganic minerals, but in actual practice, it is sometimes classified into those using glass fibers (glass wool) and those manufactured on the basis of other minerals (rock wool).

Mineral wool is an inorganic material and is relatively expensive, but it has low risk to the human body, has good high-temperature resistance, is non-combustible, and has abundant pores depending on its fiber structure, so it provides excellent thermal insulation or heat-retention effects, and therefore, when an insulation material manufactured using mineral wool is applied, the performance of a fireproof door can be improved. A mineral wool insulation material is produced by forming a molten inorganic material into fibers through high-speed rotation, applying a binder, and stacking them on a collector to form a mat, whereby a felt (mat) consisting of multiple layers is formed. Meanwhile, in the case of glass wool (glass fiber), which is a type of mineral wool, after glass fibers are manufactured, the manufactured glass fibers can be woven into a felt form, and in this case as well, the fiber orientation is uniform.

As described above, although mineral wool insulation materials has good thermal insulation and heat resistance, it is weak against moisture, and there is a problem that deformation due to the self-weight during use creates empty spaces inside a fireproof door, thereby partially lowering thermal insulation efficiency. Further, insulation material made of mineral wool for filling fireproof doors has a problem that it is weak against impact in the planar direction because multiple layers of fiber material are used as the basic structure of the insulation materials.

Therefore, when mineral wool insulation material is applied to fireproof doors, there are several issues to be improved, such as a problem that empty spaces are generated due to an increase in load caused by moisture and a problem that the strength in the planar direction is lows.

### SUMMARY

The present disclosure has been made in an effort to solve the problems described above and an objective of the present disclosure is to provide a method for manufacturing a recycled fiber insulation board for fireproof doors which provides, as a filling material for fireproof door frames, a recycled fiber insulation board that is manufactured by processing fiber-based insulation material waste and that is excellent in heat resistance, insulation performance, and strength, and is also resistant to moisture at a low cost, and a recycled fiber insulation board manufactured by the method.

Another objective of: the present disclosure is to provide a method for manufacturing a recycled fiber insulation board for fireproof doors which allows a recycled fiber insulation board to be manufactured in a non-complicated manner to be suitable for use as a filling material for fireproof doors by using fiber-based insulation material waste, which is difficult to dispose of and requires high cost, so that the cost and environmental destruction associated with landfill of waste is reduced and the performance of fireproof doors can be enhanced, and a recycled fiber insulation board manufactured by the method.

Another objective of the present disclosure is to provide a method for manufacturing a recycled fiber insulation board for fireproof doors that cuts a recycled fiber insulation board such that boards of different sizes are combined to be adjusted to the dimensions of fireproof door frames of various sizes, that can provide recycled fiber insulation boards produced in limited sizes to match the dimensions of fireproof door frames of various sizes, and that disperses the fiber orientation direction of the recycled fiber insulation board and forces caused by the self-weight or external force, and a recycled fiber insulation board manufactured by the method.

A method for manufacturing a recycled fiber insulation board for fireproof doors according to an embodiment of the present disclosure includes: a first process of obtaining fiber shreds in which dust and foreign matters are separated by crushing fiber-based insulation material waste through a crushing screen having holes of 10˜100 mm; a second process of preparing a fiber slurry by applying the fiber shreds to a solution composed of water, a water-soluble binder, and a water-repellent agent and then mixing the fiber shreds and the solution; a third process of manufacturing a recycled fiber insulation board with fiber orientation in multiple directions by applying the slurry to a mold and forming the slurry into a board shape at a temperature of 150-300□ under pressure to achieve a density of 100-200 kg/cm³; a fourth process of cutting the recycled fiber insulation board to match dimensions of a fireproof door frame.

As an example, the second process may include a process of mixing 500˜900 parts by weight of water, 70˜100 parts by weight of a water-soluble acrylic binder, and 2˜5 parts by weight of a silane-based water-repellent agent for 100 parts by weight of the fiber shreds.

Meanwhile, the water-soluble acrylic binder used herein may be of an acrylic type, may have a solids content of 5˜15 percent by weight, and may have a glass transition temperature of 60□ or higher.

As an example, the second process may be to perform mixing at high speed of 300 rpm or more to separate fiber bundles from the fiber shreds and then perform stirring for mixing at low speed of 200 rpm or less such that the separated fiber bundles become entangled with each other without directionality.

As an example, the fourth process may be to cut the recycled fiber insulation board to match the dimensions of the fireproof door frame through combination of boards of different sizes so that a fiber orientation of the recycled fiber insulation board and forces caused by self-weight or external forces are dispersed

Meanwhile, the method may further includes a fifth process of stacking the cut recycled fiber insulation boards of different sizes after the fourth process and arranging the cut and stacked recycled fiber insulation boards to match the dimensions of the fireproof door frame when the cut and stacked recycled fiber insulation boards are combined in a fitting manner.

According to the method for manufacturing a recycled fiber insulation board and the recycled fiber insulation board manufactured by the method of the present disclosure, since a recycled fiber insulation board having random fiber orientation and excellent water repellency is provided by processing fiber-based insulation material waste, which has conventionally been disposed of by landfill, through a relatively simple method, there is an effect of improving the quality of fireproof doors, which use, as a filing material, a recycled fiber insulation board for fireproof doors that has excellent heat resistance, thermal insulation, strength, and moisture resistance at low cost, and reducing manufacturing costs.

Further, by recycling fiber-based insulation material waste, which is difficult to dispose of as waste and requires high costs, to be suitable as a filling material for fireproof doors, there is an effect of reducing waste disposal costs and environmental damage while improving the performance of fireproof doors.

Furthermore, when the recycled fiber insulation board is cut and boards of different sizes are arranged in an alternating manner, by cutting them to match the dimensions of a fireproof door frame, the fiber orientation of the insulation board and forces caused by self-weight or external forces are dispersed. Accordingly, there is an effect of increasing durability and enabling recycled fiber insulation boards, which are produced in limited sizes, to be provided to match the dimensions of fireproof door frames of various sizes.

### BRIEF DESCRIPTION OF THE DRAWINGS

FIG. 1 is an exemplary view showing the structure of a fireproof door frame to which an insulation material is applied;

FIG. 2 is a typical fiber-based insulation material;

FIG. 3 is an example of a fireproof door filling material formed by cutting insulation materials perpendicular to the fiber orientation and then combining them to increase the strength of fiber-based insulation materials of the related art;

FIG. 4 is a flowchart showing a method for manufacturing a recycled fiber insulation board for fireproof doors according to the present disclosure;

FIG. 5 is an exemplary view showing a fiber slurry preparation process according to an embodiment of the present disclosure and a fiber sample obtained through the process;

FIGS. 6 and 7A-7B are exemplary views showing the shapes and fiber orientation directions of a recycled fiber insulation board according to an embodiment of the present disclosure and a fiber-based insulation material of the related art;

FIGS. 8 and 9 are exemplary views showing a method of applying a recycled fiber insulation board according to an embodiment of the present disclosure to a fireproof door frame;

FIGS. 10 to 11 are exemplary views showing the cut and applied states recycled fiber insulation boards according to another embodiment of the present disclosure; and

FIG. 12 is an exemplary view showing the cutting and stacking results for fitting recycled fiber insulation boards according to another embodiment of the present disclosure.

### DETAILED DESCRIPTION

It should be noted that technical terms used herein are used only in order to describe specific exemplary embodiments rather than limiting the present disclosure. Further, the technical terms used herein should be construed as meanings that are generally understood by those skilled in the art unless specifically defined as other meanings in the present disclosure, and should not be construed as excessively comprehensive meanings or excessively reduced meanings. Further, when the technical terms used herein wrong technical terms that do not exactly express the spirit of the present disclosure, they should be replaced with technical terms that can be understood right by those skilled in the art. Further, general terms used herein should be construed on the basis of previous and following contexts in accordance with those defined in dictionaries and should not be construed as excessively reduced meanings.

Further, singular forms that are used in this specification are intended to include plural forms unless the context clearly indicates otherwise. In the present disclosure, terms “configured”, “include”, or the like should not be construed as necessarily including several components or several steps described in the present disclosure, in which some of the t components or steps may not be included or additional components or steps may be further included.

Further, terms including ordinals such as first and second used herein may be used to describe components, but components should not be limited by the terms. Terms are used to only discriminate one component from another component. For example, the ‘first’ component may be named the ‘second’ component, and vice versa, without departing from the scope of the present disclosure.

Hereafter, preferred embodiments of the present disclosure will be described in detail with reference to the accompanying drawings and the same or similar components are given the same reference numerals regardless of the numbers of figures and are not repeatedly described.

Further, in description of the present disclosure, detailed descriptions of well-known technologies will be omitted not to obscure the description of the present disclosure with unnecessary details. Further, it should be noted that the accompanying drawings are provided only for easy understanding of the spirit of the present disclosure and the spirit of the present disclosure should not be construed as being limited to the accompanying drawings.

In particular, the term “fiber-based insulation material” used in describing the present disclosure refers to an insulation material that uses, as a main material, various types of inorganic fibers defined as mineral wool. In particular, the “fiber-based insulation material” in the present disclosure includes various forms of insulation materials in which inorganic fibers are processed into a felt (mat) form and used as is, or used with an additional binder applied.

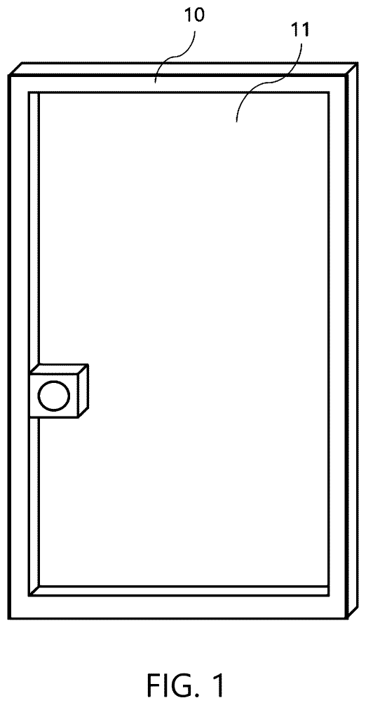

FIG. 1 is an exemplary view showing the structure of a fireproof door frame to which an insulation material is applied.

A fireproof do or is generally composed of a metal frame and an insulating filling material because it must delay the spread of flames and smoke in the event of a fire. Accordingly, a fireproof door frame 10, as shown in the figure, is prepared with one side open, its internal space 11 is filled with a filling material for fireproof doors, and once the filling material for fireproof doors is filled, the open side is subsequently finished with a metal plate, whereby a fireproof door is completed. Although not shown, the fireproof door frame 10 may include a door frame in which a fireproof door is to be mounted, and typically, the interior of the door frame is also filled with the same filling material for fireproof doors.

The filling material that fills the internal space 11 of the fireproof door frame 10 must satisfy conditions such as not only thermal insulation and non-combustibility, but also support for loads, maintenance of strength against impact, and maintenance of component performance.

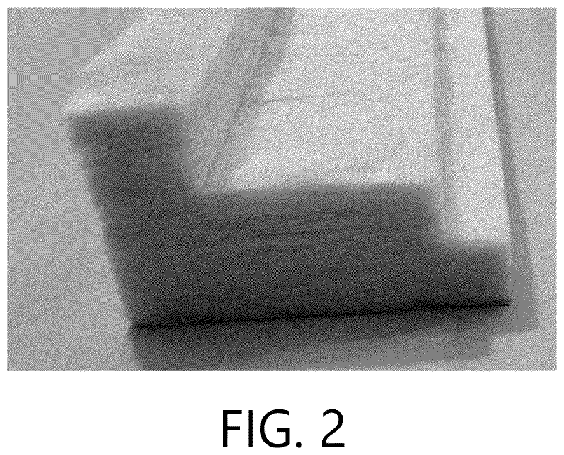

FIG. 2 shows the form of a general fiber-based insulation material.

The fiber-based insulation material shown in the figure is a commonly used mineral wool insulation material formed by mixing a binder with inorganic fibers. Since it is manufactured by collecting fibrous raw materials, the fiber orientation is consistently maintained, which results in a structure in which multiple layers of fibers are stacked, similar to a pastry.

In the case of such a fiber-based insulation material, it is effective for use as an insulation material on various objects such as surfaces and curved shapes; however, it is vulnerable to moisture, and when applied as a vertical board, the upper end gradually sag due to moisture and self-weight, and it is weak against impact in the planar direction, various problems are generated when it is used as a filling material for fireproof doors.

That is, general fiber-based insulation materials have difficulty meeting the standards for load support, maintenance of strength against impact, and maintenance of component performance required for use as a filling material for fireproof doors.

Furthermore, since general fiber-based insulation materials absorb moisture, when applying an adhesive (typically a urethane adhesive) to attach them to a fireproof door frame, a considerable amount of adhesive must be applied, and to prevent sagging due to self-weight, the adhesive must be evenly applied over a wide area. However, in the case of such adhesives, during a fire, the adhesives combust and generate gases, and the gases may accumulate at the top of a fireproof door and ignite flames; therefore, applying a large amount of adhesive reduces the reliability of a fireproof door.

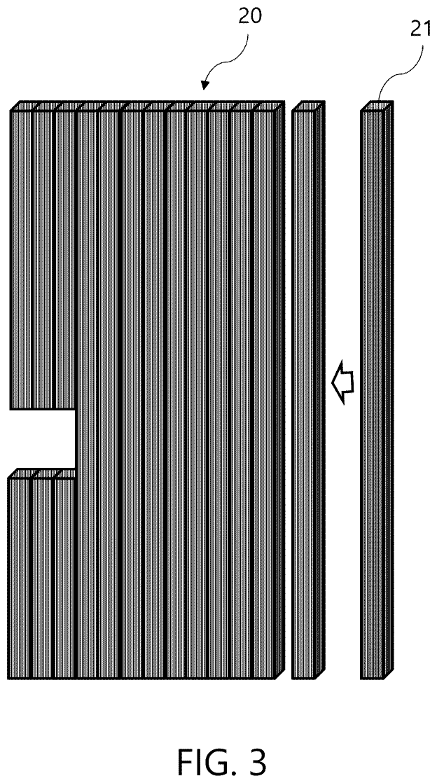

Meanwhile, since the fiber-based insulation material shown in FIG. 2 is weak against impact in the planar direction and has low strength to withstand self-weight and maintain its shape, when it is made into a board form and applied to the fireproof door frame 10, a filling material 20 made by cutting and recombining a fiber-based insulation material, as shown in FIG. 3, has also been used.

FIG. 3 is an example of a fireproof door filling material formed by cutting insulation materials perpendicular to the fiber orientation and then combining them to increase the strength of fiber-based insulation materials of the related art. As shown in the figure, in the case of the fiber-based insulation material, processing such as pressing or applying a binder is performed to form it into a board shape, so the surface has relatively higher strength than the interior. Therefore, by vertically cutting a board-shaped fiber-based insulation material, rotating the cut unit insulation materials 21 by 90 degrees, and then combining them, the resistance in the vertical direction is increased, and the material can withstand planar impact to some extent.

However, such a filling material 20 is difficult to process and is costly, and despite this processing, it is vulnerable to moisture and has high elasticity, so impact resistance is low and it is difficult to meet the standards required for a fireproof door filling material.

The present disclosure provides a method for manufacturing a recycled fiber insulation board for fireproof doors that is suitable as a fireproof door filling material by recycling scraps or discarded fiber-based insulation materials generated during manufacturing of fiber-based insulation materials, in order to solve the problems arising when existing fiber-based insulation materials are used as fireproof door filling materials and to reduce the burden of high manufacturing costs of existing fiber-based insulation materials.

In general, fiber-based insulation materials (insulation materials that use mineral wool as the main material) are widely used in various industrial fields such as building insulation material and piping insulation material. In the case of fiber-based insulation material waste, such as scraps generated during the manufacturing process or discarded insulation materials replaced or disposed of after use in various industries, they cannot be disposed of through incineration due to high heat resistance (typically above 650□) and flame-retardant and non-combustible properties, so all of the waste must be landfilled as designated waste, which results in high disposal costs and environmental damage.

Until now, research for recycling such inorganic fiber insulation material waste has been limited to a method for producing fiber-reinforced plastics (FRP) with enhanced resin strength by obtaining fibers from waste fiber insulation materials or a method for re-melting the waste to use it as an inorganic fiber raw material. However, recently, technologies by the present applicant have been disclosed, including a technique (Registered Patent No. 10-2526169) for obtaining glass wool again by processing scraps generated during manufacturing of glass wool insulation materials of inorganic fiber insulation materials, and a method (Registered Patent No. 10-2526168) for producing exterior boards by impregnating such recycled glass wool with a binder and then pressing it after applying a water-repellent coating.

However, the methods of the related art were intended to recycle scraps obtained from the manufacturing process of insulation materials rather than from waste insulation materials, and these methods were complicated. Further, even in the case of producing insulation boards, the processes were designed assuming use as exterior materials, so the processes were complex.

An objective of the present disclosure is not to produce an insulation material for general use or for exterior material, but to produce a filling material that is applied to the inside of the specialized frame of a fireproof door, which allows the manufacturing process of a recycled fiber insulation board for fireproof doors to be simplified.

In particular, the present disclosure is not aimed merely at recycling discarded or difficult-to-dispose fiber-based insulation material waste for cost purposes despite a decline in performance and quality, but is technically characterized by processing fiber-based insulation material waste during recycling to have fiber properties suitable for a filling material for fireproof doors, thereby providing new characteristics, which cannot be offered by newly manufactured fiber-based insulation materials, through recycling.

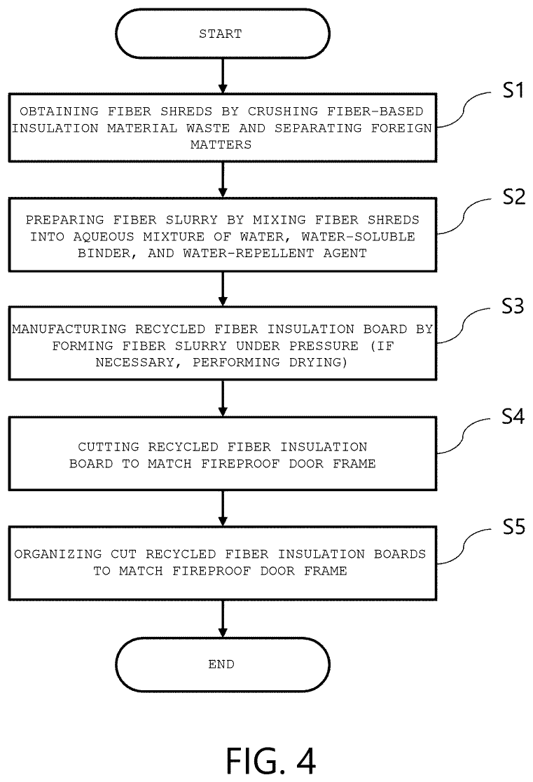

FIG. 4 is a flowchart showing a method for manufacturing a recycled fiber insulation board for fireproof doors according to the present disclosure.

First, the method includes a first step (S1) of obtaining fiber shreds in which dust and foreign matters are separated by crushing fiber-based insulation material waste, a second step (S2) of preparing a fiber slurry by applying the fiber shreds to a solution composed of water, a water-soluble binder, and a water-repellent agent and then mixing them, a third step (S3) of producing a recycled fiber insulation board with fiber orientation in multiple directions by applying the slurry to a mold and forming it into a board shape at a temperature of 150˜300□ under pressure to achieve a density of 100˜200 kg/cm³, and a fourth step (S4) of cutting the recycled fiber insulation board to match the dimensions of a fireproof door frame.

The method may further include a fifth step (S5) of organizing the cut recycled fiber insulation board to match a fireproof door frame. The recycled fiber insulation board cut to match the fireproof door frame may consist of multiple boards, and, if necessary, may be composed of multiple layers. Therefore, recycled fiber insulation boards cut for respective fireproof door frames can be sorted and organized separately, or bonded in multiple layers and then sorted and organized.

First, the first step (S1) is a process of obtaining fiber shreds by crushing fiber-based insulation material waste. Since the fiber shreds are irregularly shaped and their size is difficult to define, the size of the fiber shreds was defined by the hole size of the crushing screen in a crusher performing the crushing. In the present disclosure, it is preferable to use a crushing screen with holes of 10˜100 mm, and most preferably to use a crushing screen with holes of 20˜80 mm.

The fiber-based insulation material waste (scraps or discarded insulation material) may be one of glass fiber insulation material waste, mineral wool insulation material waste, or ceramic fiber insulation material waste, and, if necessary, multiple types of fiber insulation materials may be used.

In the first step (S1), fine fibers and foreign matters are removed from the fiber shreds obtained in this manner, thereby obtaining refined fiber shreds. For example, the fiber shreds from the crusher can be conveyed to a dust removal device equipped with a vibration unit, and then the fines and foreign matters can be separated.

The second step (S2) involves preparing a fiber slurry by applying the fiber shreds to a solution composed of water, a water-soluble binder, and a water-repellent agent and then mixing them. For 100 parts by weight of the fiber shreds, 500˜900 parts by weight of water, 70˜100 parts by weight of a water-soluble acrylic binder, and 2˜5 parts by weight of a silane-based water-repellent agent can be mixed.

The water-soluble acrylic binder used herein is of an acrylic type, has a solids content of 5˜15 percent by weight, and may have a glass transition temperature of 60□ or higher.

The water-repellent agent used herein may be a silane-based water-repellent agent, which can prevent deterioration of properties such as thermal insulation or strength of an insulation material due to moisture by effectively forming a water-repellent film on the surface of fibers. If necessary, a water-repellent agent of a type other than silane-based may also be used.

In order to form a slurry and to enhance the strength of the subsequently formed board by separating fiber bundles from the fiber shreds such that they entangle with each other, the aqueous mixture used in the present disclosure primarily consists of only three components: water, a water-soluble acrylic binder, and a silane-based water-repellent agent, unlike other prior techniques. Other types of flexibilizers, water glass (sodium silicate), glass bubbles, protective water-repellent agents, or separate coating agents are not used; nevertheless, the quality of the fireproof door filling material is not affected.

In particular, the core of the present disclosure is that fiber bundles obtained from fiber shreds entangle with each other to form clumps, and that the form of the fiber bundle clump entangled in the slurry is maintained, thereby randomly dispersing the fiber orientation of the recycled fiber insulation board to be manufactured afterward. To this end, in the process of mixing the fiber shreds into the aqueous mixture, at first, the mixture is stirred at a relatively high speed to separate the fiber bundles from the fiber shreds, and thereafter, it is stirred at relatively low speed so that the fiber bundles having fiber lengths corresponding to the shape of the fiber shreds entangle and form clumps.

When the slurry containing such fiber bundle clumps is formed under high temperature and pressure in the following third process (S3), a recycled fiber insulation board in which the fiber orientation is dispersed in multiple directions can be obtained.

That is, the second process (S2), can perform stirring at 300 rpm or more to separate fiber bundles from the fiber shreds, and after the fiber shreds are separated into fiber bundles through high-speed stirring, perform stirring for at 200 rpm or less such that the fiber bundles become entangled with each other to form clumps. Such stirring speeds and times may vary depending on the type of fiber shreds to be applied.

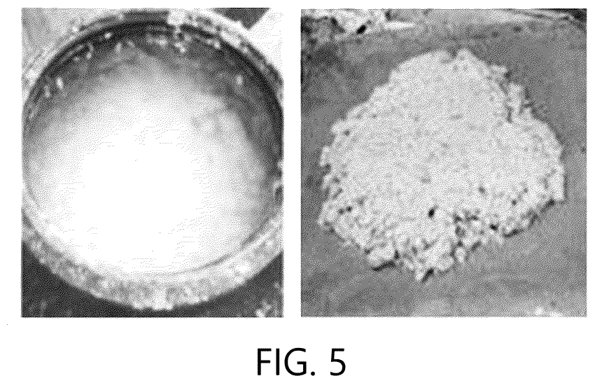

FIG. 5 is an exemplary view showing a fiber slurry preparation process according to an embodiment of the present disclosure and a fiber sample of the slurry obtained therefrom (clumps of fiber bundles taken from the slurry), and as shown in the figure, the fiber bundles become entangled with each other to form clumps of a certain size, and such clumps of fiber bundles are mixed in a state without orientation.

The third process (S3) is a process of applying the slurry to a mold and forming it into a board shape by performing pressure dehydration under heating conditions, wherein the slurry is formed into a board shape by a hot press at a temperature of 150˜300□ and pressure-molded to achieve a density of 100˜200 kg/cm³, thereby manufacturing a recycled fiber insulation board in which the fiber orientation is in multiple directions.

If necessary, the hot-pressed recycled fiber insulation board may be dried in a drying oven.

For example, the mold applied to the hot press may have a rectangular shape of 1160 mm×600 mm, and the slurry is formed into a 20 mm-thick board through pressing under a heating condition of 200□ for 20 minutes and then completely dried in a microwave drying oven, whereby it is possible to manufacture a recycled fiber insulation board (A) with dimensions of 1000 mm×600 mm and a density of 140 kg/m³. The size and shape of the mold, heating condition, drying condition, and density may be variously modified depending on production process efficiency, limitations of machinery, minimization of loss, constraints of the molding process, product requirements, and the like.

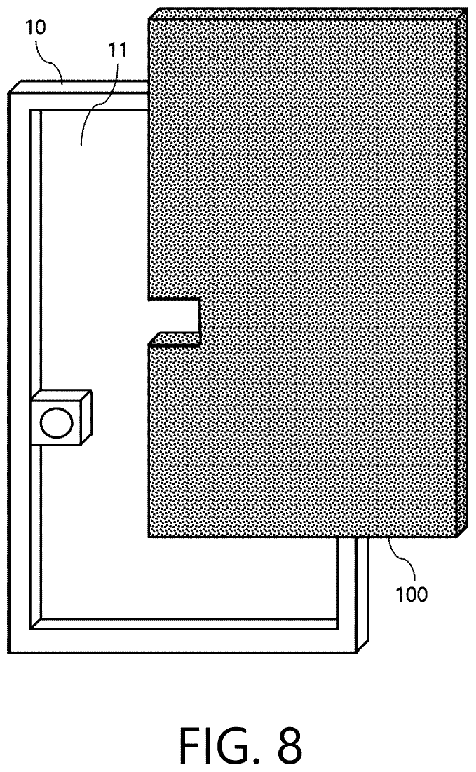

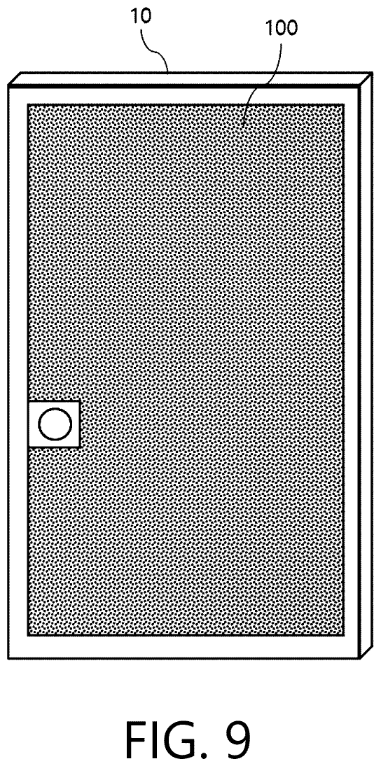

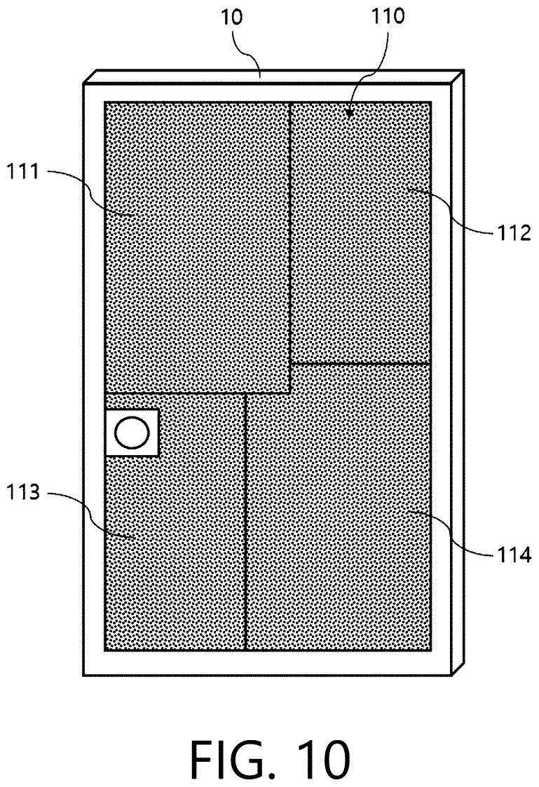

The fourth process (S4) is a process of cutting the recycled fiber insulation board to match the dimensions of a fireproof door frame, and for general use, all four sides may be cut to a predetermined size (for example, 1000 mm×600 mm), whereby it is possible to provide a standardized recycled fiber insulation board. Of course, as shown in FIGS. 8 and 9 to be described below, the recycled fiber insulation board may be cut to match the internal space of a fireproof door frame, and as in the embodiment to described with reference to FIGS. 10 to 12, the recycled fiber insulation board may also be cut into multiple pieces so that boards of different sizes are combined to match the dimensions of a fireproof door frame.

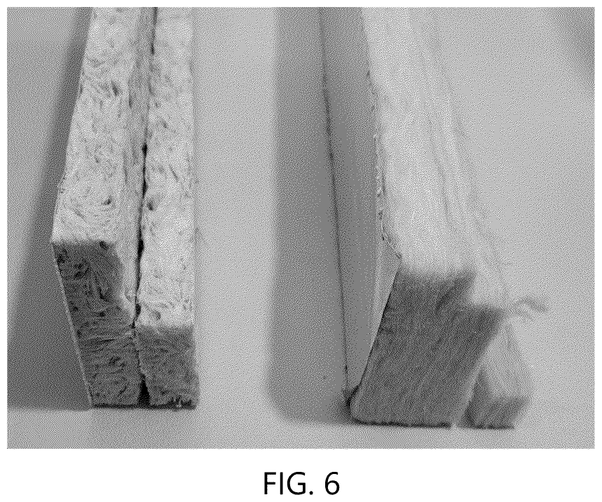

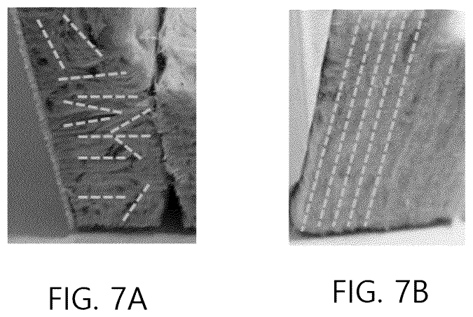

FIGS. 6 and 7A-7B are exemplary views showing the shapes and fiber orientation directions of a recycled fiber insulation board according to an embodiment of the present disclosure and a fiber-based insulation material of the related art.

In FIG. 6, the left one shows a recycled fiber insulation board according to an embodiment of the present disclosure, and the right one shows a fiber-based insulation material of the related art. As shown in the figure, the recycled fiber insulation board according to an embodiment of the present disclosure has fiber orientations in multiple directions and forms a single board piece, whereas the fiber-based insulation material of the related art has a consistent fiber orientation and multiple fiber layers are combined to form a board.

FIG. 7A partially shows the fiber orientation observed at a cut portion of the recycled fiber insulation board shown in FIG. 6 according to the present disclosure, and FIG. 7B partially shows the fiber orientation observed at a cut portion of the fiber-based insulation material of the related art shown in FIG. 6. As shown in the figures, it can be seen that the recycled fiber insulation board of the present disclosure has fibers extremely randomly arranged because it is formed by pressing clumps of fiber bundles having fiber orientations in multiple directions included in the slurry. Therefore, it provides high strength against pressure in the planar direction and is robust against loads from any direction. In addition, since the clumps of fiber bundles are compressed, the overall density is high and the fiber orientations inside are also random, which makes it difficult for moisture to penetrate.

In particular, water repellency and moisture resistance are different properties, and even if fibers themselves have water repellency, when the fiber pores are large, moisture can be absorbed and retained in those pores. Even if the fibers used in fiber-based insulation materials of the related art have water repellency, the structure of insulation materials tends to retain moisture, and external ventilation is required to remove such moisture. Since fireproof doors are enclosed and are in an environment in which condensation occurs, fiber-based insulation materials of the related art absorb moisture, so the self-weight increases. However, the present disclosure provides a structure that has a water-repellent effect from the application of a water-repellent agent and generally does not absorb moisture by the compression of the fiber bundle slurry, so it has excellent moisture resistance, which is advantageous in maintaining the shape.

FIGS. 8 and 9 are exemplary views showing a method of applying a recycled fiber insulation board according to an embodiment of the present disclosure to a fireproof door frame.

As shown in the figures, through the fourth process (S4), a single piece of recycled fiber insulation board for fireproof doors 100 is produced by cutting the recycled fiber insulation board manufactured in the third process (S3) to match the internal space of a fireproof door frame, and the recycled fiber insulation board for fireproof doors 100 can be applied to the internal space 11 of the fireproof door frame 10. In this case, the internal surface of the fireproof door frame 10 and the recycled fiber insulation board for fireproof doors 100 may be bonded with an adhesive, and the recycled fiber insulation board for fireproof doors 100 of the present disclosure does not absorb the adhesive, so the amount of adhesive required can be reduced, whereby it is possible to reduce the risk of flame generation due to combustion gases from the adhesive in the event of a fire.

Meanwhile, when the recycled fiber insulation board that is applied to the fireproof door frame 10 is cut and applied as a single board, cracks may occur at areas where forces are concentrated due to loads or impacts. Therefore, in the fourth process (S4), it is possible to cut the recycled fiber insulation board so that boards of different sizes are combined to match the dimensions of the fireproof door frame, in order to disperse the fiber orientation and forces caused by self-weight or external forces.

When boards of various sizes are combined as a filing material that match the dimensions of a fireproof door frame, it becomes easier to accommodate the dimensions of multiple types of fireproof door frame 10 using recycled fiber insulation boards manufactured with a mold of a predetermined size. For reference, leftover portions of the recycled fiber insulation board after cutting can be used as a filing material for the door frame, which is part of the fireproof door.

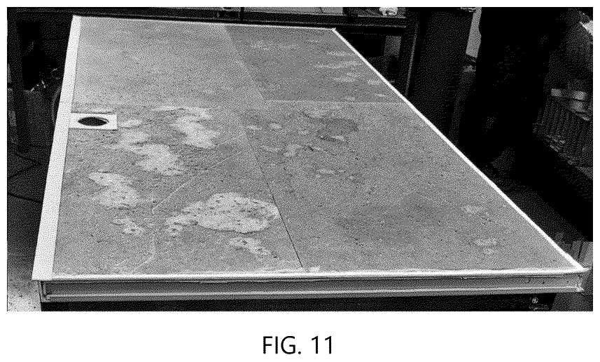

FIGS. 10 to 11 are exemplary views showing the cut and applied states of recycled fiber insulation boards according to another embodiment of the present disclosure.

The recycled fiber insulation board for fireproof doors 110 shown in FIGS. 10 and 11 is composed of four recycled fiber insulation boards 111, 112, 113, and 114. In the case shown in the figures, two kinds of recycled fiber insulation boards having different sizes are provided, and the overlapping portions are additionally cut so that they are fitted and the loads of forces are dispersed across each other, whereby it is possible to reduce the occurrence of cracks or breakage in the recycled fiber insulation board due to self-weight or external forces.

Of course, the recycled fiber insulation boards can be cut into different combinations of numbers and sizes other than those shown in the figures.

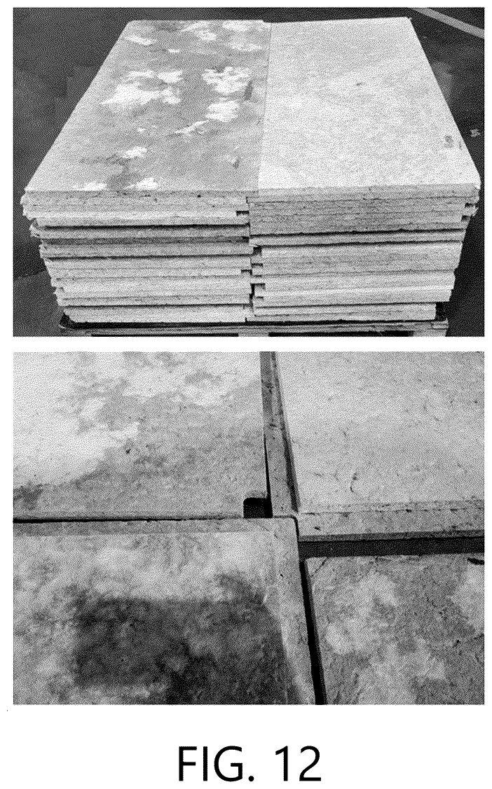

FIG. 12 is an exemplary view showing the cutting and stacking results for fitting recycled fiber insulation boards according to another embodiment of the present disclosure.

Recycled fiber insulation boards can be stacked to correspond to the height of the internal space of a fireproof door frame. When recycled fiber insulation boards are cut as in the combination shown in FIG. 10, recycled fiber insulation boards cut into the same size can be stacked. Further, when the recycled fiber insulation boards cut and stacked as shown in FIG. 12 are assembled in a fitting manner, they can be stacked to match the dimensions of a fireproof door frame. In such stacking, the boards can be fixed using an adhesive.

As shown in FIG. 12, when recycled fiber insulation boards cut into different sizes are stacked and fixed, they can be assembled in a fitting manner, so it is possible to provide a more robust recycled fiber insulation board for fireproof doors.

Of course, such cutting and stacking configurations for fitting of the recycled fiber insulation boards can be variously modified

The fifth step (S5) is a process of organizing the recycled fiber insulation boards to match a fireproof door frame. As described above with reference to FIGS. 10 to 12, when multiple sheets of recycled fiber insulation boards cut to match a fireproof door frame are provided, the recycled fiber insulation boards for one fireproof door frame may be sorted and organized as a single set. In the case where recycled fiber insulation boards must be configured in multiple layers, as shown in FIG. 12, the recycled fiber insulation boards may be bonded in multiple layers according to predetermined dimensions and then organized as one set for a single fireproof door frame. Alternatively, recycled fiber insulation boards of the same size and shape may be sorted and organized separately.

The above description may be changed and modified by those skilled in the art without departing from the fundamental characteristics of the present disclosure. Accordingly, the embodiments described herein are provided merely not to limit, but to explain the spirit of the present disclosure, and the spirit of the present disclosure is not limited by the embodiments. The protective range of the present disclosure should be construed by the following claims and the scope and spirit of the present disclosure should be construed as being included in the range of right of the present disclosure.

### EXPLANATION OF REFERENCE NUMERALS

10: Fireproof door frame
11: Internal space
20: Filling material
100, 110: Recycled fiber insulation board for fireproof doors

What is claimed is:

1. A method for manufacturing a recycled fiber insulation board for fireproof doors, the method comprising:
a first process of obtaining fiber shreds in which dust and foreign matters are separated by crushing fiber-based insulation material waste through a crushing screen having holes of 10˜100 mm;
a second process of preparing a fiber slurry by applying the fiber shreds to a solution composed of water, a water-soluble binder, and a water-repellent agent and then mixing the fiber shreds and the solution;
a third process of manufacturing a recycled fiber insulation board with fiber orientation in multiple directions by applying the slurry to a mold and forming the slurry into a board shape at a temperature of 150-300° C. under pressure to achieve a density of 100-200 kg/cm³;
a fourth process of cutting the recycled fiber insulation board to match dimensions of a fireproof door frame.

2. The method of claim 1, wherein the second process includes a process of mixing 500˜900 parts by weight of water, 70˜100 parts by weight of a water-soluble acrylic binder, and 2˜5 parts by weight of a silane-based water-repellent agent for 100 parts by weight of the fiber shreds.

3. The method of claim 2, wherein the water-soluble acrylic binder is of an acrylic type, has a solid content of 5˜15 percent by weight, and has a glass transition temperature of 60° C. or higher.

4. The method of claim 1, wherein the second process is to perform mixing at high speed of 300 rpm or more to separate fiber bundles from the fiber shreds and then perform stirring for mixing at low speed of 200 rpm or less such that the separated fiber bundles become entangled with each other without directionality.

5. The method of claim 1, wherein the fourth process is to cut the recycled fiber insulation board to match the dimensions of the fireproof door frame through combination of boards of different sizes so that a fiber orientation of the recycled fiber insulation board and forces caused by self-weight or external forces are dispersed.

6. The method of claim 5, further comprising a fifth process of stacking the cut recycled fiber insulation boards of different sizes after the fourth process and arranging the cut and stacked recycled fiber insulation boards to match the dimensions of the fireproof door frame when the cut and stacked recycled fiber insulation boards are combined in a fitting manner.
